(19) United States
(12) Patent Application Publication
(10) Pub. No.: US 2007/0098976 A1
(43) Pub. Date: May 3, 2007

(54) Method for fabricating conductive particle and anisotropic conductive film using the same

(75) Inventors: Mi-Jung Lee, Seoul (KR); Sung-Jei Hong, Gunpo (KR); Won-Keun Kim, Osan (KR); Jeong-In Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: KOREA ELECTRONICS TECHNOLOGY INSTITUTE

(21) Appl. No.: 11/583,863

(22) Filed: Oct. 20, 2006

(30) Foreign Application Priority Data
Oct. 31, 2005 (KR) KR10-2005-0102912

(51) Int. Cl. B05D 7/00; B32B 5/16

(52) U.S. Cl. 428/323; 427/214

(57) ABSTRACT

The present invention relates to a method for fabricating a conductive particle, the method comprising steps of: (a) preparing a particle based on a macromolecular resin; (b) forming a layer of a nano powder on a surface of the particle; and (c) subjecting the layer of the nano powder to an electroless plating. In accordance with the present invention, a nano powder is bonded on a particle based on a macromolecular resin and an electroless conductive layer is plated such that a pretreatment process of a plating process for forming a conductive particle is omitted and the plating process is simplified from twice to once, thereby reducing a toxic substance generated in a conventional process to improve a stability of the process and reduce a manufacturing cost.

### RELATED APPLICATIONS

The present disclosure relates to subject matter contained in priority Korean Application No. 10-2005-0102912 filed on 31 Oct. 2005, which is herein expressly incorporated by reference in its entirety.

### BACKGROUND OF THE INVENTION

The present invention relates to a method for fabricating a conductive particle and an anisotropic conductive film using the same, and in particular, to a method for fabricating a conductive particle and an anisotropic conductive film using the same wherein a nano powder is bonded on a particle based on a macromolecular resin and an electroless conductive layer is plated such that a pretreatment process of a plating process for forming a conductive particle is omitted and the plating process is simplified from twice to once, thereby reducing a toxic substance generated in a conventional process to improve a stability of the process and reduce a manufacturing cost.

As an electronic device becomes complicated and multi-functional as well as becoming miniaturized and thin, packaging connection of an integrated circuit in the electronic device is becoming more and more important. Particularly, as a mobile communication terminal has various functions and is required to have a slim design, a research on a high density packaging of a connection device for the mobile communication terminal is becoming more active.

While the high density packaging includes a flip-flop method and a face-down method, a simple connection method using an anisotropic conductive adhesive film is more commonly used.

The anisotropic conductive adhesive film is an adhesive on a film having a conductive particle such as a metal-coated plastic or a metal particle is dispersed thereon. The anisotropic conductive adhesive film is widely used for an LCD (Liquid Crystal Display) panel in an LCD mounting field, a TCP (Tape Carrier Package) or an electrical connection between a PCB (Printed Circuit Board) and the TCP, and an adhesion of the PCB for the mobile communication terminal.

The anisotropic conductive adhesive film comprises a conductive particle and an insulating adhesive. The conductive particle is required to be uniformly distributed in a film sheet, and the anisotropic conductive adhesive film is required to have a high conductivity in a connection-wise direction while not causing an electrical short in a direction other than the connection-wise direction. For instance, the conventional anisotropic conductive adhesive film is disclosed in Korean Patent Publication No. 10-2003-0076928, titled “ANISOTROPICALLY CONDUCTIVE ADHESIVE COMPOSITION AND ANISOTROPICALLY CONDUCTIVE ADHESIVE FILM FORMED FROM IT” filed by 3M INNOVATIVE PROPERTIES COMPANY on Sep. 23, 2002 and published on Sep. 29, 2003 and Korean Patent Publication No. 10-2005-0043639, titled “INSULATED CONDUCTIVE PARTICLES AND AN ANISOTROPIC CONDUCTIVE FILM CONTAINING THE PARTICLES” filed by CHEIL INDUSTRIES INC. on Nov. 2, 2004 and published on May 11, 2005.

As the conductive particle of elements of the anisotropic conductive adhesive film, the metal particle, a resin-coated metal particle or metal-coated resin particle is used.

However, when the metal particle is used as the conductive particle, a uniform dispersion in the adhesive is not possible, a shape and a diameter thereof are non-uniform, and the electrical short between adjacent particles occurs. Moreover, when the resin-coated metal particle is used in order to prevent the electrical short, the problems of a dispersibility and a non-uniformity still remains.

Therefore, a method for coating the metal on a resin as a basic particle that provides the uniformity and the dispersibility is widely used. However, in this case, a surface of the metal may be in contact in a vertical direction of the connection-wise direction to cause the electrical short. Therefore, a triple conductive particle wherein an additional resin is coated is often used. A method for coating metal on the resin includes a physical method such as a deposition, a sputtering, a plating and a thermal spray, and a chemical method. In this case, the plating is commonly used since the metal is required to be coated on a macromolecular resin particle uniformly.

However, the plating which is widely used as a technique for manufacturing the conductive particle is disadvantageous in that the plating is harmful to an environment, and the macromolecule and a plated film is separated due to a low adhesion force between the metal layer for a conductivity and the macromolecular resin such that the metal layer cannot properly carry out a function connection.

Therefore, a method for increasing the adhesion force between the plated film and the macromolecule in order to solve the problem of separation between the macromolecular resin and the metal layer is required.

In order to achieve this, a method wherein a metal layer such a nickel having an adhesion force relatively higher than a substance used in the conventional metal is plated on the macromolecular resin-based particle and a metal having a high conductivity such as a gold has been developed. That is, the problem of the conventional macromolecular particle lies in the adhesion force of the resin particle and the metal layer. In order to increase the conductivity, while it is advantageous to coat the metal such as the gold having a low resistivity, metal is not easily plated on the macromolecule. Therefore, in order to solve the problem, two layers wherein the gold is coated after coating the nickel on the macromolecule as a buffer layer are formed.

FIG. 1 is a flow diagram illustrating a conventional plating process for manufacturing a conductive particle.

As shown in FIG. 1, a cleaning process for removing a dust or a greasy substance on a surface is carried out (S110). The cleaning process may include a solvent cleaning, an alkali cleaning and an electrolytic cleaning.

Thereafter, a cleaning process in a water for rinsing a chemical used in the cleaning process is carried out in order to allow an efficient subsequent processes.

Thereafter, an etching process for forming a microscopic concavo-convex portion is carried out (S120). For instance, in accordance with the etching process, a resin is dipped in a solution containing an oxidizing agent to increase a coarseness of the surface as well as to cause a chemical change, thereby increasing the adhesion force of the surface.

Thereafter, a surface adjustment process for neutralizing the surface that has been subjected to the etching process using a strong acid is carried out so that a subsequent plating process may be efficiently carried out (S130).

Thereafter, a pre-dip process using a hydrochloric acid and a catalytic process for forming a catalytic nucleus are carried out (S140).

Thereafter, an acceleration process is carried out (S150), and an electroless underlayer plating (S160) and an electroless conductive layer plating (S170) are carried out to complete a plating process.

However, while the nickel layer for improving the adhesion force and the gold layer having the high conductivity are coated in the conventional plating process for forming the conductive particle to manufacture the conductive particle, pretreatment processes such as the cleaning process (S110), the etching process (S120), the surface adjustment process (S130), the pre-dip/catalytic process (S140) and acceleration process (S150) are required, and substances such as the strong acid and a strong base used for carrying out the pretreatment processes generates a substance that is fatal and harmful to a human body, which is a main cause of environment pollution. Moreover, the conventional process is disadvantageous in that two plating processes including the nickel plating and the gold plating are required. In addition, a treatment process for bonding a functional group on the macromolecular resin are often required in order to increase the adhesion force between the metal layer and the macromolecule.

### SUMMARY OF THE INVENTION

It is an object of the present invention to provide a method for fabricating a conductive particle wherein a nano powder is bonded on a particle based on a macromolecular resin and an electroless conductive layer is plated such that a pretreatment process of a plating process for forming a conductive particle is omitted and the plating process is simplified from twice to once, thereby reducing a toxic substance generated in a conventional process to improve a stability of the process and reduce a manufacturing cost.

It is an object of the present invention to provide an anisotropic conductive film using the method for fabricating the conductive particle.

In order to achieve the above-described object, there is provided a method for fabricating a conductive particle, the method comprising steps of: (a) preparing a particle based on a macromolecular resin; (b) forming a layer of a nano powder on a surface of the particle; and (c) subjecting the layer of the nano powder to an electroless plating.

In accordance with the method for fabricating a conductive particle of the present invention, it is preferable that the macromolecular resin is selected from a group consisting of an acrylic resin, a urethane resin and an ethylene resin.

In accordance with the method for fabricating a conductive particle of the present invention, it is preferable that wherein the particle has a diameter ranging from 1 to 30 μm.

In accordance with the method for fabricating a conductive particle of the present invention, it is preferable that the nano powder is selected from a group consisting of a Ni, an Ag, a Cu, an Al, a Cr, mixtures thereof and compounds thereof.

In accordance with the method for fabricating a conductive particle of the present invention, it is preferable that the nano powder is selected from a group consisting of a Pt, a Pd, a Sn—Pd and a Sn—Pt.

In accordance with the method for fabricating a conductive particle of the present invention, it is preferable that the layer of the nano powder has a thickness ranging from 1 to 500 nm.

In accordance with the method for fabricating a conductive particle of the present invention, it is preferable that the step (b) comprises forming the layer of the nano powder using a dry physical adhesion.

In accordance with the method for fabricating a conductive particle of the present invention, it is preferable that the electroless plating in the step (c) comprises an electroless gold plating.

In accordance with the method for fabricating a conductive particle of the present invention, it is preferable that the method further comprises cleaning a surface of the nano powder after forming the layer of the nano powder using a dry physical adhesion.

There is also provided an anisotropic conductive film manufactured using the method for fabricating a conductive particle of the present invention.

### BRIEF DESCRIPTION OF THE DRAWINGS

FIG. 1 is a flow diagram illustrating a conventional plating process for manufacturing a conductive particle.

FIG. 2 is a flow diagram illustrating a method for fabricating a conductive particle in accordance with a preferred embodiment of the present invention.

FIG. 3 is a magnified view illustrating a conductive particle fabricated using a method for fabricating a conductive particle in accordance with a preferred embodiment of the present invention.

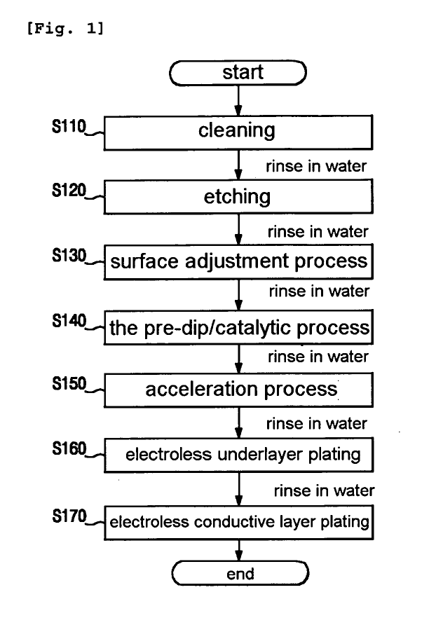

### DETAILED DESCRIPTION OF THE INVENTION

The above-described objects and other objects and characteristics and advantages of the present invention will now be described in detail with reference to the accompanied drawings.

FIG. 2 is a flow diagram illustrating a method for fabricating a conductive particle in accordance with a preferred embodiment of the present invention.

As shown, the method for fabricating a conductive particle in accordance with a preferred embodiment of the present invention comprises three steps.

Firstly, a particle based on a macromolecular resin is prepared (S210).

It is preferable that the macromolecular resin is selected from a group consisting of an acrylic resin, a urethane resin and an ethylene resin, and the particle based on the macromolecular resin is a spherical particle having a diameter ranging from 1 to 30 μm.

Thereafter, a layer of a nano powder is formed on a surface of the particle (S230). The formation of the layer may be carried out using a dry physical adhesion. The nano powder is for replacing an underlayer for plating a metal layer having a high conductivity, and a substance which allows an electroless plating on a surface thereof after the formation is used. For instance, the nano powder may be a Ni, an Ag, a Cu, an Al, a Cr, mixtures thereof or compounds thereof, and have a thickness ranging from 1 to 500 nm. A Pt, a Pd, a Sn—Pd or a Sn—Pt may also be used.

Although not shown, a cleaning process of a surface of the nano powder may further be carried out.

After carrying out the step S230, the layer of the nano powder is subjected to an electroless plating of a metal having the high conductivity to form a conductive layer (S250). For instance, an Au may be plated by the electroless plating.

As described above, in accordance with the method for fabricating the conductive particle, a pretreatment process of a plating process for forming a conductive particle required in the conventional method may be omitted and the plating process may be carried out only once contrary to twice in the conventional method to allow a manufacturing of the conductive particle by the electroless plating.

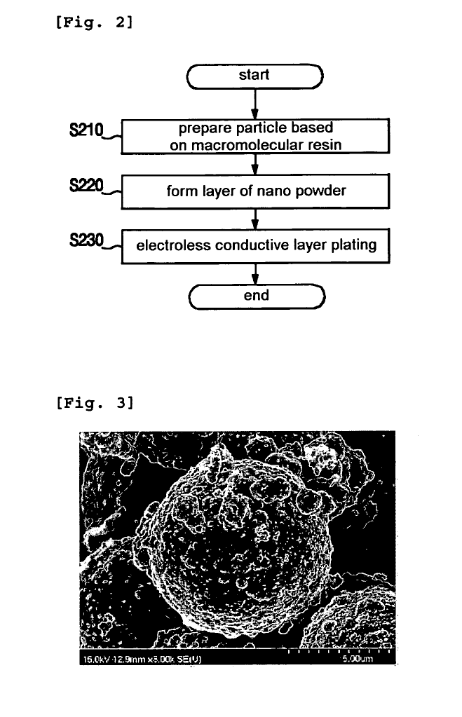

FIG. 3 is a magnified view illustrating a conductive particle fabricated using a method for fabricating a conductive particle in accordance with a preferred embodiment of the present invention.

The conductive particle shown in FIG. 3 is a result of carrying out the dry physical adhesion using a hybridization equipment manufactured by Nara Machinery Corporation for 3 minutes at a speed of 16000 rpm, wherein 25 grams of the layer of the nano powder consisting of the Cu having a diameter of 90 nm is formed on 25 grams of the particle based on the macromolecular resin of PMMA 4 μm ball, and carrying out the cleaning process and the electroless gold plating.

In addition, the present invention provides an anisotropic conductive film manufactured using the method for fabricating the conductive particle. The anisotropic conductive film is fabricated using the conductive particle described with reference to FIG. 2. The anisotropic conductive film is identical to the conventional anisotropic conductive film except that the conductive particle manufactured using the method shown in FIG. 2. therefore, a detailed description is omitted.

While the present invention has been particularly shown and described with reference to the preferred embodiment thereof, it will be understood by those skilled in the art that various changes in form and details may be effected therein without departing from the spirit and scope of the invention as defined by the appended claims.

As described above, in accordance with the present invention, a nano powder is bonded on a particle based on a macromolecular resin and an electroless conductive layer is plated such that a pretreatment process of a plating process for forming a conductive particle is omitted and the plating process is simplified from twice to once, thereby reducing a toxic substance generated in a conventional process to improve a stability of the process and reduce a manufacturing cost.

What is claimed is:

1. A method for fabricating a conductive particle, the method comprising steps of:
(a) preparing a particle based on a macromolecular resin;
(b) forming a layer of a nano powder on a surface of the particle; and.
(c) subjecting the layer of the nano powder to an electroless plating.

2. The method in accordance with claim 1, wherein the macromolecular resin is selected from a group consisting of an acrylic resin, a urethane resin and an ethylene resin.

3. The method in accordance with claim 1, wherein the particle has a diameter ranging from 1 to 30 μm.

4. The method in accordance with claim 1, wherein the nano powder is selected from a group consisting of a Ni, an Ag, a Cu, an Al, a Cr, mixtures thereof and compounds thereof.

5. The method in accordance with claim 1, wherein the nano powder is selected from a group consisting of a Pt, a Pd, a Sn—Pd and a Sn—Pt.

6. The method in accordance with claim 1, wherein the layer of the nano powder has a thickness ranging from 1 to 500 nm.

7. The method in accordance with claim 1, wherein the step (b) comprises forming the layer of the nano powder using a dry physical adhesion.

8. The method in accordance with claim 1, wherein the electroless plating in the step (c) comprises an electroless gold plating.

9. The method in accordance with claim 1, further comprising cleaning a surface of the nano powder after forming the layer of the nano powder using a dry physical adhesion.

10. An anisotropic conductive film manufactured using method according to one of claims 1 through 9.
